(19) United States
(12) Patent Application Publication
(10) Pub. No.: US 2009/0140019 A1
(43) Pub. Date: Jun. 4, 2009

(54) APPLIANCE-SUPPORTING STRAP SYSTEM AND METHOD

(76) Inventor: Shawn Martinich, Missoula, MT (US)

Correspondence Address: HOLLAND & HART, LLP, P.O BOX 8749, DENVER, CO, 80201, US

(21) Appl. No.: 12/062,079

(22) Filed: Apr. 3, 2008

Related U.S. Application Data
(60) Provisional application No. 60/992,052, filed on Dec. 3, 2007.

(51) Int. Cl. A45F 3/14; B65G 65/00

(52) U.S. Cl. 224/257; 414/800

(57) ABSTRACT

The technology of the present application provides a strap system for carrying a load. The strap system generally comprises a first loop, a second loop and a connector for connecting the first loop and the second loop. The loops may include a shoulder portion for being draped over the shoulder of a user. The strap system may also be adapted to a cargo net by using multiple connectors attached to the corners of the cargo net. The loops are then threaded through multiple connectors. The technology of the present application also provides a method for carrying a load.

This application claims the benefit of priority to U.S. Provisional Application Ser. No. 60/992,052, filed Apr. 5, 2007, the entirety of which is hereby incorporated by reference.

### BACKGROUND

1. Field

The present invention relates to a system for carrying objects, such as large appliances. More particularly, the present invention relates to a strap system adapted for use by one or more individuals for supporting and carrying an object.

2. Background

Many strap systems for lifting and carrying large, cumbersome objects exist. Such systems traditionally require the central portion of the strap system to be positioned under the object while end portions of the strap system extend out from underneath the object. The end portions are then used by individuals to lift the object off the ground and carry the object to a desired destination.

U.S. Pat. No. 2,431,780, issued to Theal, illustrates one embodiment of this general configuration for a strap system. In the '780 patent, the end portions of the strap system that extend out from underneath the object to be carried terminate in a complicated harness. To wear the harness, the user must extend each arm backwards through the harness much like if the user were putting on a jacket. Accordingly, the harness may not be taken off quickly or easily in the case of an emergency. U.S. Published Patent Application No. 2005/0263551 illustrates a similarly complicated harness which, according to FIG. 4 of the published application, must be put on by placing the harness over the user's head, much like one would put on a T-shirt.

U.S. Pat. No. 5,503,448, issued to Dewey, illustrates another embodiment of this general configuration for a strap system. In the '448 patent, the central portion of the strap system located under the object is a buckle through which the straps extending out to the users are threaded. When not in use, the buckle may be adjusted to alter, for example, the length of the strap system. However, when it use, the buckle securely holds the straps and does not allow for movement of the straps extending out to the users. In this manner, the buckle of the strap system does not allow for lateral movement of the straps extending out to the user or any other “in-use” adjustment of the straps. Accordingly, users of the strap system disclosed in the '448 patent may find the strap system inflexible and inconvenient to use.

U.S. Pat. No. 6,039,376, issued to Lopreiato, illustrates still another embodiment of this general configuration for a strap system. In the '376 patent, the user lifts the object by placing his arms through holes in the end of the straps extending from under the object to be carried. In such an embodiment where the forearms serve as the point of connection between the user and the strap system, the user must use his arms, back and shoulders to lift the object, rather than primarily his legs. Such a design is not ergonomic and could potentially lead to severe back injury.

Accordingly, a need exists for a strap system for carrying a load that is convenient and easy to put on and take off, provides flexibility during use and that does not pose potential health risks to the user due to the strains placed on parts of the body such as the back.

### SUMMARY

Embodiments disclosed herein address the above stated needs by providing a strap system comprising a first loop, the first loop comprising a first strap having a first end and a second end, the first end comprising a first connector, wherein the second end is engaged in the first connector to thereby form the first loop; a second loop, the second loop comprising a second strap having a first end and a second end, the first end comprising a second connector, wherein the second end is engaged in the second connector to thereby form the second loop; and a figure-eight shaped connector having a first opening and a second opening, wherein the first loop is threaded through the first opening and the second loop is threaded through the second opening.

In another embodiment, the above stated needs are addressed by providing a strap system comprising a cargo net having four corners and being adapted for carrying an object; a figure-eight shaped connector coupled to each of the four corners, wherein each of the figure-eight shaped connectors comprises a first opening and a second opening and a mid portion separating the two opening and the corners of the cargo net are each coupled to one of the connectors via the second opening in the connector; a first loop, the first loop comprising a first strap having a first end and a second end, the first end comprising a first connector, wherein the second end is threaded through the second openings in two adjacent figure-eight shaped connectors and the second end is engaged in the first connector to thereby form the first loop; and a second loop, the second loop comprising a second strap having a first end and a second end, the first end comprising a second connector, wherein the second end is threaded through the second openings in two adjacent figure-eight shaped connectors through which the first strap has not been threaded and the second end is engaged in the second connector to thereby form the second loop.

In yet another embodiment, the above stated needs are addressed by providing a method for carrying a load, the method comprising providing a plurality of loops and a loop connector, each loop being threaded through the loop connector; positioning the loop connector under a load to be carried and positioning a portion of each of the plurality of loops to extend out from under the load to be carried; positioning each portion of the plurality of loops extending out from under the load around one of a plurality of lifts; and tensioning the plurality of loops by raising the lifts to thereby raise the load.

The foregoing, as well as other features, utilities, and advantages of the invention will be apparent from the following more particular description of a preferred embodiment of the invention as illustrated in the accompanying drawings.

### BRIEF DESCRIPTION OF THE DRAWINGS

FIG. 1 shows a side view of a strap system according to an embodiment of the present application;

FIGS. 2 and 3 show side views of a strap used in the strap system shown in FIG. 1;

FIG. 4 shows a side view of a connector used in the strap system shown in FIG. 1;

FIG. 5 shows a perspective view of the connector shown in FIG. 4;

FIG. 6 shows a top view of the connector shown in FIG. 4;

FIG. 7 shows a side view of the strap system shown in FIG. 1 in use by two people to carry a load;

FIG. 8 shows a side view of the strap system shown in FIG. 1 as it is used to engage a load;

FIG. 9 shows a perspective view of the strap system shown in FIG. 1 in use by two people to carry a load;

FIG. 10 shows another side view of the strap system shown in FIG. 1 in use by two people to carry a load;

FIG. 11 shows a perspective view of the underside of the strap system shown in FIG. 1 in use by two people about to carry a load;

FIG. 12 shows a top view of a cargo net to be used with the straps shown in FIGS. 2 and 3;

FIG. 13 shows a perspective view of the cargo net shown in FIG. 12;

FIG. 14 shows an expanded view of a corner of the cargo net shown in FIG. 12;

FIG. 15 shows a side view of the cargo net shown in FIG. 12 folded along its longitudinal axis;

FIG. 16 shows a perspective view of the cargo net shown in FIG. 12 folded along its longitudinal axis;

FIG. 17 shows a side view of the cargo net of FIG. 15 having the straps shown in FIGS. 2 and 3 engaged therewith.

FIG. 18 shows a perspective view of the cargo net of FIG. 15 having the straps shown in FIGS. 2 and 3 engaged therewith;

FIG. 19 shows a side view of the cargo net and straps shown in FIG. 17 having a load deposited therein;

FIG. 20 shows a perspective view of the cargo net and straps shown in FIG. 17 having a load deposited therein.

### DETAILED DESCRIPTION

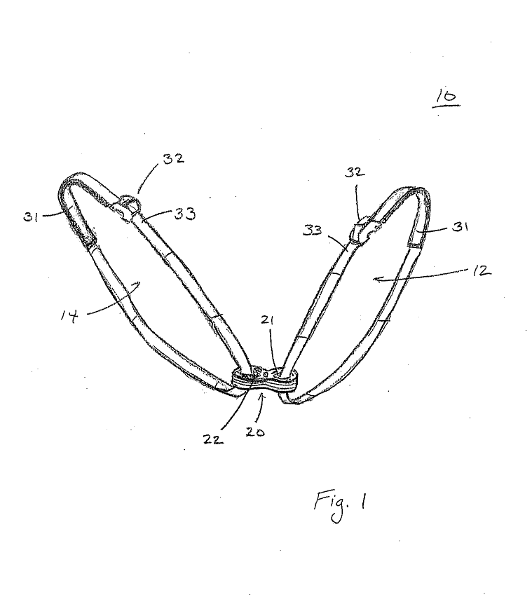

A strap system 10 according to the first embodiment is illustrated in FIG. 1. The strap system comprise a first loop 12, a second loop 14 and a connector 20. The connector 20 has a first opening 21 and a second opening 22 to thereby form a figure eight shaped connector 20. The first loop 12 is threaded through the first opening 21 in the connector 20 and the second loop 14 is threaded through the second opening 22 in the connector 20. The loops 12, 14 are loosely connected to the connector 20 so as to permit the loops 12, 14 to move relative to the connector 20. This permits the position of a load being carried to be adjusted during use.

The first loop 12 comprises a first connector 32, which may be used to open and close the first loop 12. Similarly, the second loop 14 comprises a second connector 32, which may be used to open and close the second loop 14. The first and second connectors 32 may be located at a portion of the first and second loop 12, 14, respectively, furthest away from the figure-eight shaped connector 20. Each of the loops 12, 14 are single loops designed to go over a shoulder of a person using the strap system 10.

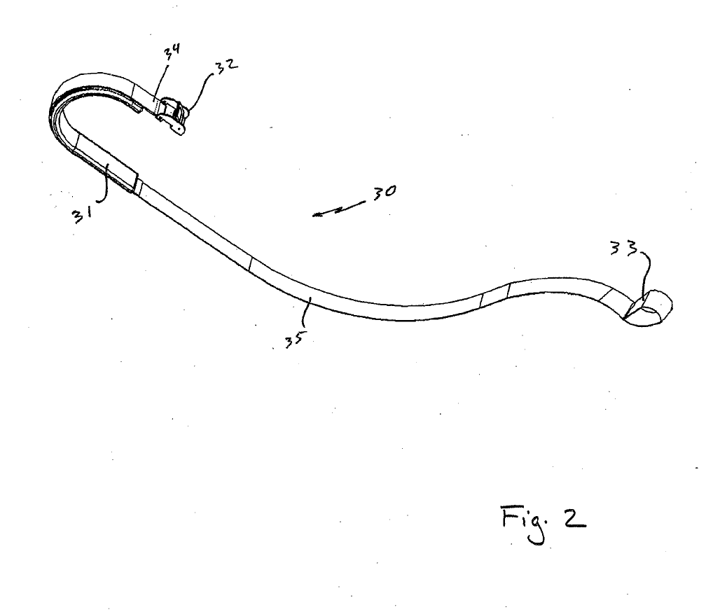

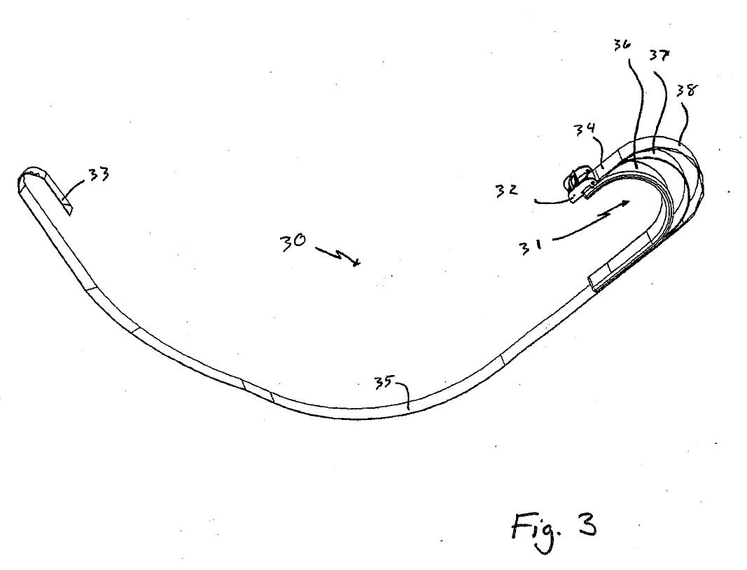

FIGS. 2 and 3 illustrate the strap 30 that forms the first and second loops 12, 14. The strap 30 includes a first end 33 and a second end 34 separated by a mid-portion 35. The material of the strap is not limited. In one embodiment, the strap is a strong material that does not easily tear. For example, the material of the strap may be a high strength cloth material or leather. The length of the strap 30 is also not limited. The length of the strap 30 should be suitably large so as to provide a loop 12, 14 that can accommodate both the user and loads of varying sizes. As described in greater detail below, the size of the loops 12, 14 may be adjusted.

The second end 34 of the strap 30 may include the connection means 32 mentioned above. The first end 33 is connected to the second end 34 via the connection means 32 to create the first and second loops 12, 14.

In the embodiment illustrated in FIGS. 2 and 3, the connection means 32 is a buckle. Any type of buckle may be used. In one aspect of the embodiment, the buckle is a cam buckle. The first end 33 may be inserted and pulled through the cam buckle to create the first or second loop 12, 14. Use of a cam buckle allows the size of the first or second loop 12, 14 to be adjusted. Where a smaller first or second loop 12, 14 is desired, more of the first end 33 is pulled through the cam buckle prior to depressing the tab on the cam buckle to lock the first end 33 in place.

In another aspect of the embodiment, the buckle is a push button buckle, such as those commonly used in a automobile seatbelt. The female portion of the push button buckle is located at the second end 34 of the strap 30 and the male portion of the buckle is located at the first end 33. The male portion is inserted into the female portion to connect the first end 33 to the second 34 and create first or second loop 12, 14. To disconnect the first end 33 from the second end 34, the button on the female portion is depressed, which allows the male portion to disengage from the female portion. This type of buckle may also allow the size of the loop to be adjustable, such as by allowing the male portion of the buckle to slide up and down the first end 33.

While the connectors 32 may be buckles as described above, any other suitable means for connecting the first end 33 to the second 34 to create first or second loop 12, 14 may be used. For example, snap buttons, hooks and zippers may also be used as the mechanism for connecting the first end 33 to the second end 34 to create a first or second loop 12, 14.

The strap 30 that forms the first and second loop 12, 14, may also include a shoulder portion 31. The shoulder portion 31 is designed to rest on the user's shoulder when the strap system is in use, and may include a padded portion to ease the load on the user's shoulder. FIG. 3 shows an assembly view of one embodiment of the shoulder portion 31 of the strap 30. In this example, the shoulder portion 31 includes a segment 38 of the strap 30, a shoulder pad 37, and a Velcro pad 36 that connects to the shoulder pad 37. In one embodiment, the shoulder pad 37 is approximately two feet long and extends from the connector 32 down the length of the strap 30. In one embodiment, the Velcro pad 36 detachably connects to the shoulder pad 37 and is approximately 2½ feet long. In the example shown in FIG. 3, the buckle 32 is a cam buckle 32 as described above.

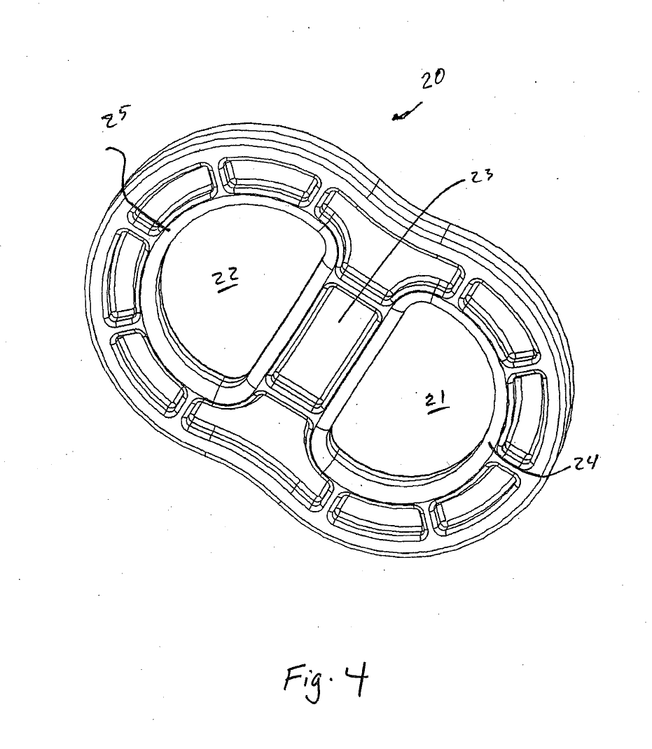

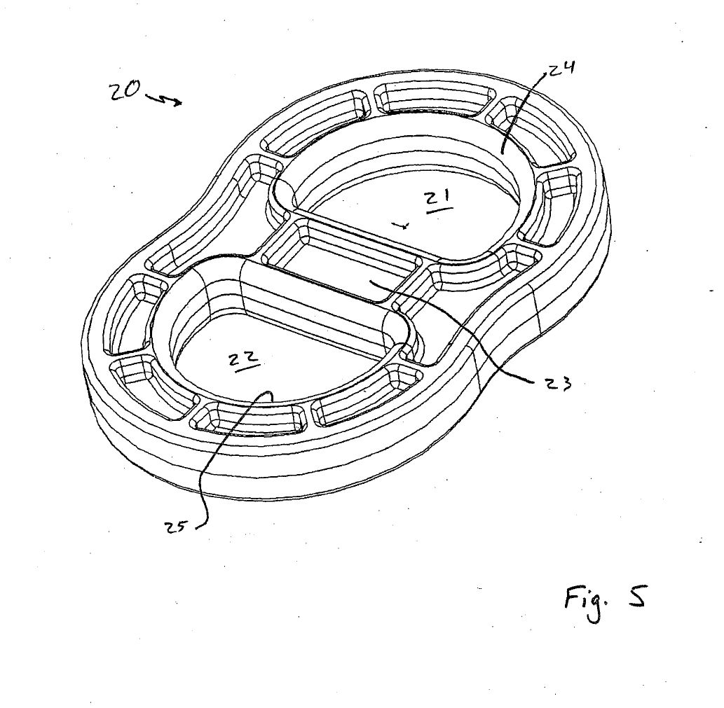

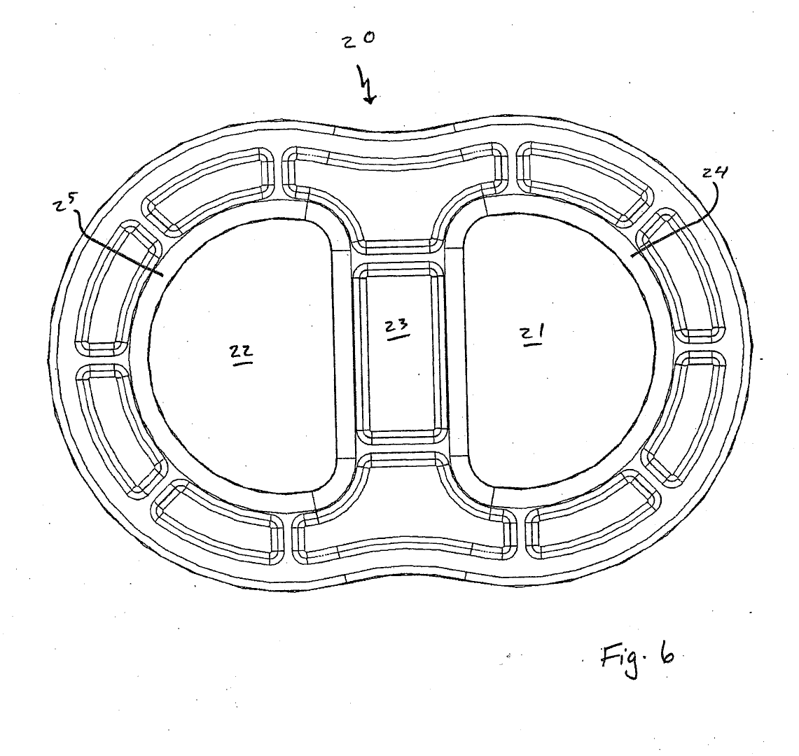

FIGS. 4-6 illustrate various views of the connector 20 used in the strap system shown in FIG. 1. As shown in FIGS. 4-6, the connector 20 has a generally figure-eight shape. First opening 21 is separated from second opening 22 by middle portion 23 of the connector. In use, the first loop 12 is threaded through the first opening 21 and the second loop 14 is threaded through the second opening 22. In this manner, the connector 20 connects the first loop 12 to the second loop 22 while not letting the two loops 12, 14 contact each other

The first opening 21 and second opening 22 have a generally circular shape. As shown in FIGS. 4-6, the portion of the openings 21, 22 defined by the middle portion 23 may be flat while the portion of the openings 21, 22 opposite the middle portion 23 are curved.

Additionally, the curved portions of the openings 21, 22 each have rounded surfaces 24, 25 connecting the top face of the connector 20 to the bottom face of the connector. The circular shape of the openings 21, 22 along with the rounded surfaces 24, 25 of the openings 21, 22 permit the loops 12, 14 to move more freely when carrying a load. For example, the shape of the openings permit the loops 12, 14 to move laterally relative to the connector 20 when in use in order to adjust the position of the load being carried.

The material and size of the connector 20 are not limited. In one embodiment, the connector 20 is formed from a rigid plastic or nylon material. In another embodiment, the connector 20 may be formed from a metal or similar high strength material.

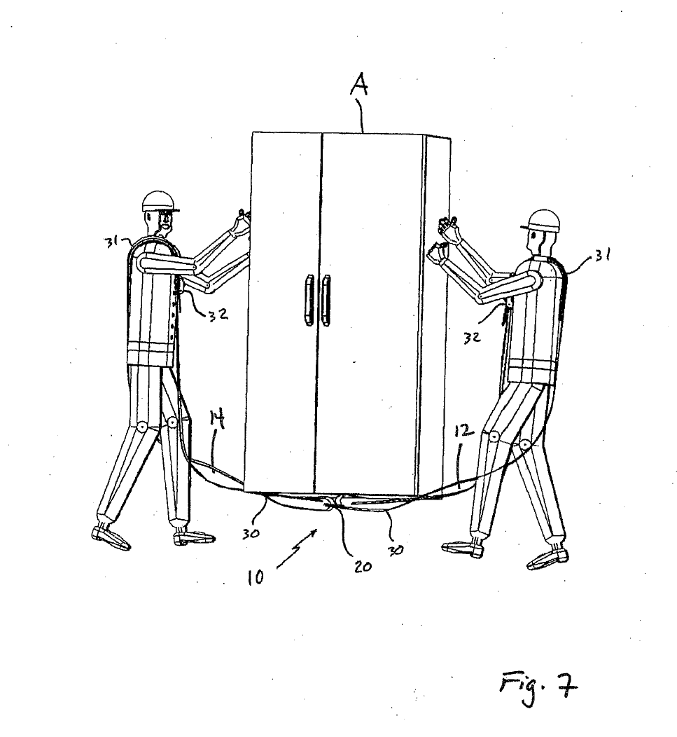

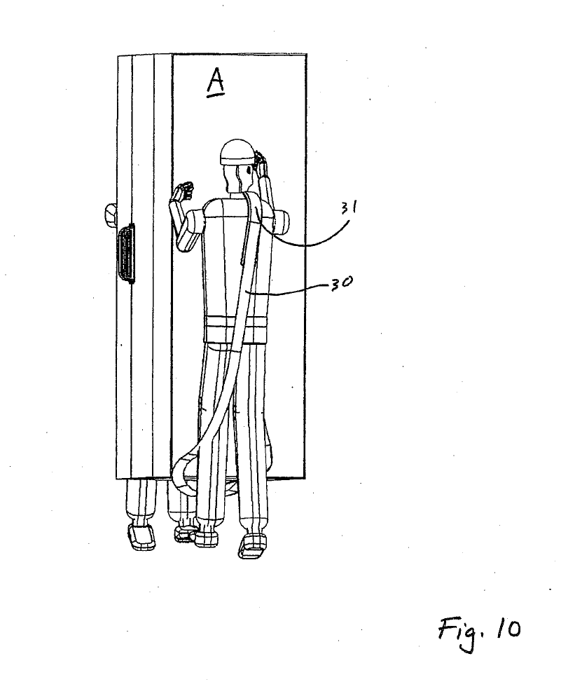

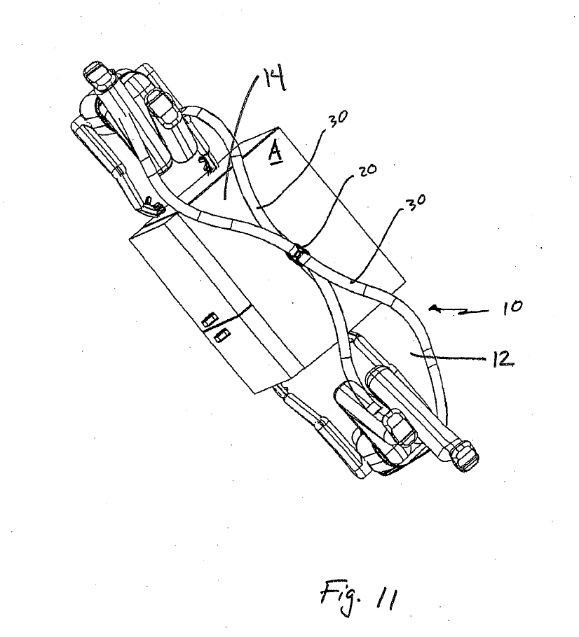

The strap system in operation is illustrated in FIGS. 7-11. As described in more detail previously, the strap system 10 includes first and second straps 30 forming first and second loops 12, 14. The first and second loops 12, 14 are connected to each other at a connector 20. A user positions himself in the middle of the loop 12, 14 and then places the loop over a shoulder. The shoulder portion 31 of each loop 12, 14, described in greater detail above, passes over the person's shoulder.

In FIG. 7, an appliance A is shown lifted off the ground so that it may be carried. Users of the strap system 10 are positioned on opposite sides of the appliance A, and the loops 12, 14 are positioned over one shoulder of each of the users. In FIG. 7, the connector 32 (for example, a buckle) is positioned relatively high on the user's chest. This permits the user to easily adjust the buckle during use. As shown, the strap system 10 permits individuals to manually carry the appliance A in an upright position, which can make it easier to maneuver around corners, through doorways, and up and down stairs.

The single loop for each user design of the strap system 10 makes it easy for the user to engage the strap system 10 by simply stepping into the loop 12, 14 that is created by the strap 30. It also permits the user to easily and quickly slip out of the strap system 10, for example, in case of emergency. Also, the strap system 10 directs the weight of the object A toward the user's legs, rather than the back or arms. The user can use the legs to lift the weight of the load, rather than the back or arms, thereby potentially avoiding injury.

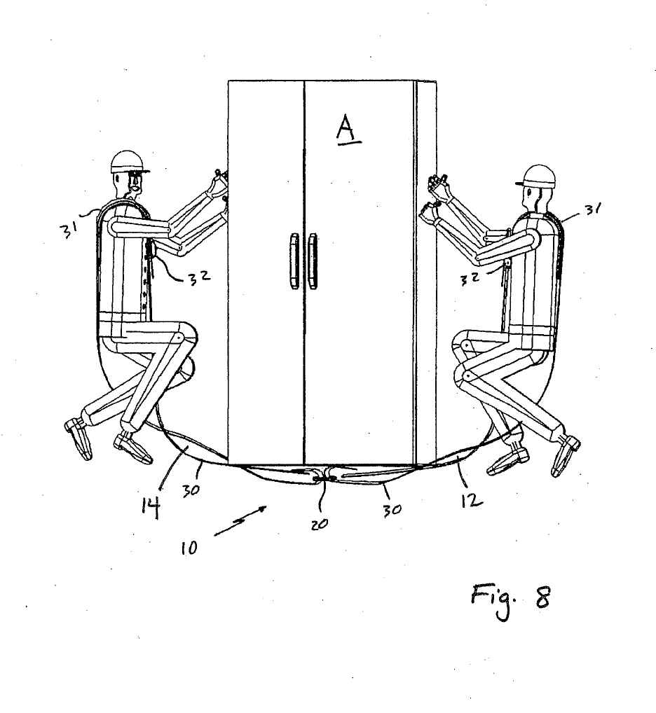

FIG. 8 illustrates the strap system 10 positioned about the appliance A prior to the appliance A being lifted off the ground. As can be seen, the connector 20 having the first loop 12 and second loop 14 connected thereto is positioned under the appliance A. In one aspect, the connector 20 is positioned under the appliance A directly in the middle of the appliance A. However, the connector 20 may be positioned elsewhere under the appliance A. As also shown in FIG. 8, portions of the loops 12, 14 extend out from under the appliance A. In one aspect, the portions of the loops 12, 14 extend out from under the appliance to opposite sides of the appliance A, although they may extend out from under the appliance A at other positions about the appliance A.

With portions of the loops 12, 14 extending out from under the appliance A at opposite sides of the appliance A, the users step into the loop 12, 14 and kneels down close to the ground. In this kneeled position, the user positions the loop 12, 14 over a shoulder. The shoulder portion 31 of the loop 12, 14 may be aligned with the shoulder of the user so as to make the strap system 10 more comfortable to the user. The user may also adjust the size of the loops 12, 14 at this time to ensure that upward movement by the user will lift the appliance A off the ground (i.e., ensure that the size of the loop 12, 14 is not so large that a portion of the slack in the loop 12, 14 will not be taken up upon upward movement of the user).

Once the loop 12, 14 is positioned over the shoulder of the user and the size of the loop 12, 14 has been adjusted to an appropriate size, the users rise to a standing position. Any slack in the loops 12, 14 is taken up during the upward movement of the users having the loops 12, 14 positioned over their shoulder. Prior to standing in a fully erect position, any slack in the loops 12, 14 is fully pulled taught, and therefore any further upward movement by the users causes the taught loops 12, 14 extending under the appliance A and connected by the connector 20 to lift the appliance A off the ground. The upward movement of the users and the corresponding upward movement of the loops 12, 14 draped of the shoulder of the user applies tension to the strap system 10, and when fully taught, any further upward movement of the strap system 10 lifts the appliance A off the ground. Once off the ground, the users may move freely to carry the appliance A to a different location In one aspect of the invention, the users rise from a kneeling position at approximately the same time and at approximately the same rate so that the appliance A rises evenly.

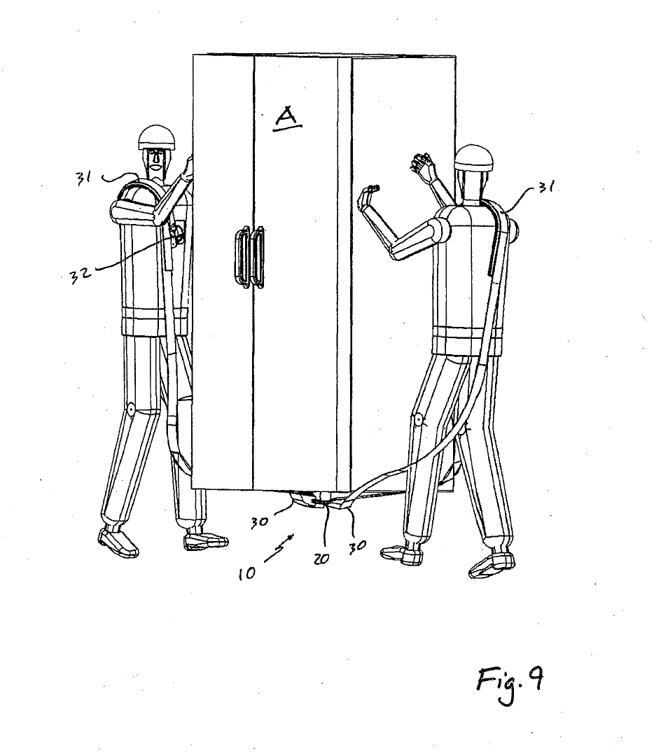

FIGS. 9, 10 and 11 show additional views of the strap system in application.

While the above description of the strap system 10 describes a person as the means for lifting the strap system 10 and the appliance A located therein, other lifts may be used with the strap system 10 to lift the load off the ground. For example, the loops 12, 14 may be draped over a jack. The jack may then be engaged to raise the loops 12, 14 and lift the load off the ground once the strap system 10 is pulled taught. Similarly, an automated machine, such as an assembly line robot, may be used as the lift.

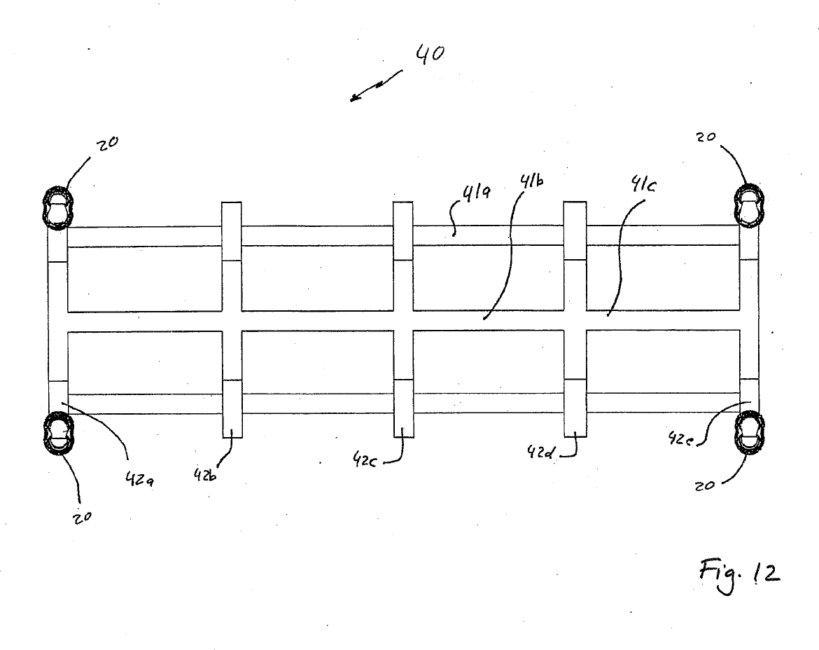

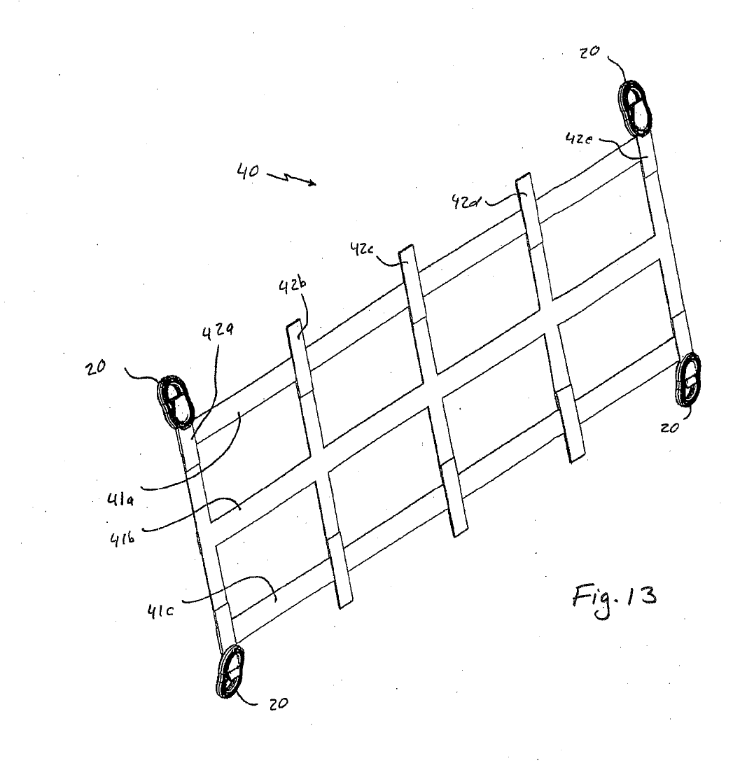

In another embodiment described herein, a cargo net utilizing a variation on the strap system for carrying a load is disclosed. FIGS. 12 and 13 illustrates a cargo net 40 including three elongated straps 41a, 41b and 41c that connect to crossing straps 42a, 42b, 42c, 42d, 42e. In alternates aspects, the cargo net may have more or less than three elongated straps and more or less than five crossing straps. The material of the cargo net is not limited, and may be a high strength material, such as high strength fabric material or leather.

The cargo net has four corners (i.e., both ends of crossing straps 42a and 42e), to which connectors 20 are attached. The connectors 20 are identical to those described above. The connectors 20 permit the cargo net 40 to be used in connection with the strap system described herein.

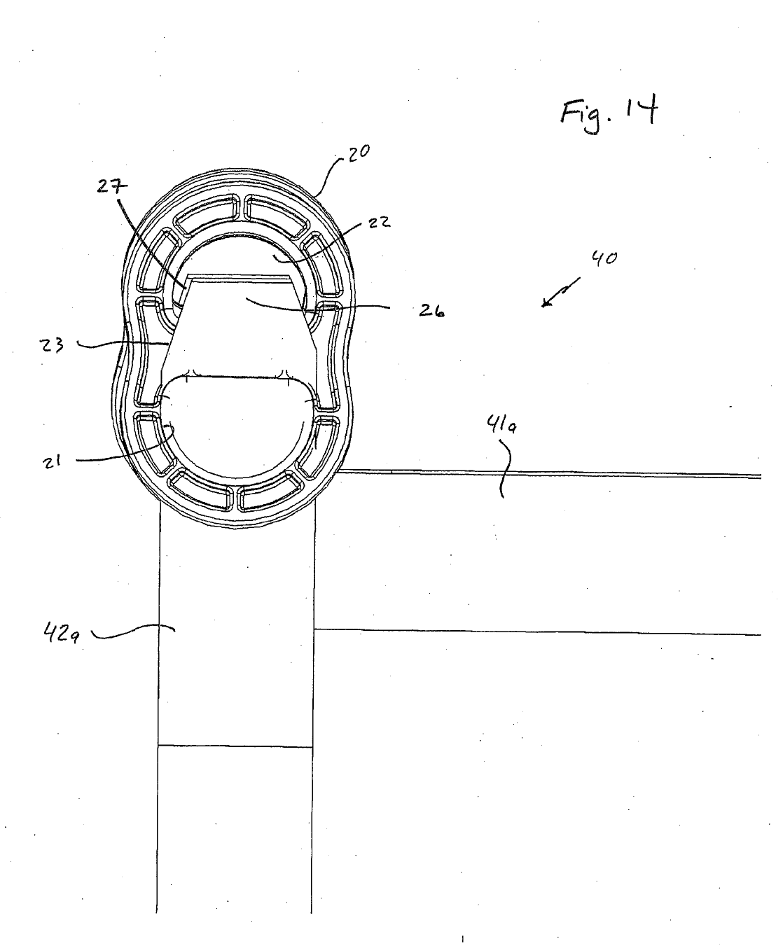

FIG. 14 illustrates an expanded view of a corner of the cargo net 40 shown in FIGS. 12 and 13. The corner of the cargo net (i.e., an end of the crossing strap 42a or 42e) includes a front flap 26 and back flap 27. The front flap 26 goes in front of the mid portion 23 and the back flap 27 goes behind the mid portion 23. The ends of the flaps 26, 27 are then joined together such that the mid portion 23 is located between the flaps. Securing the ends of the flaps 26, 27 effectuates a connection between the connector 20 and the cargo net. A connector 20 is connected to each corner of the cargo net 40 in this manner. The means for connecting the ends of the flaps 26, 27 is not limited and may be accomplished by means of, for example, zippers, snaps, hooks, or they may be sewn together.

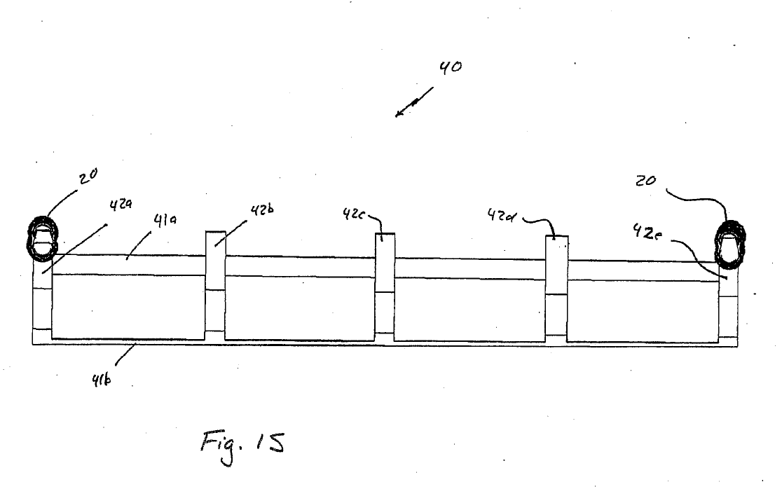

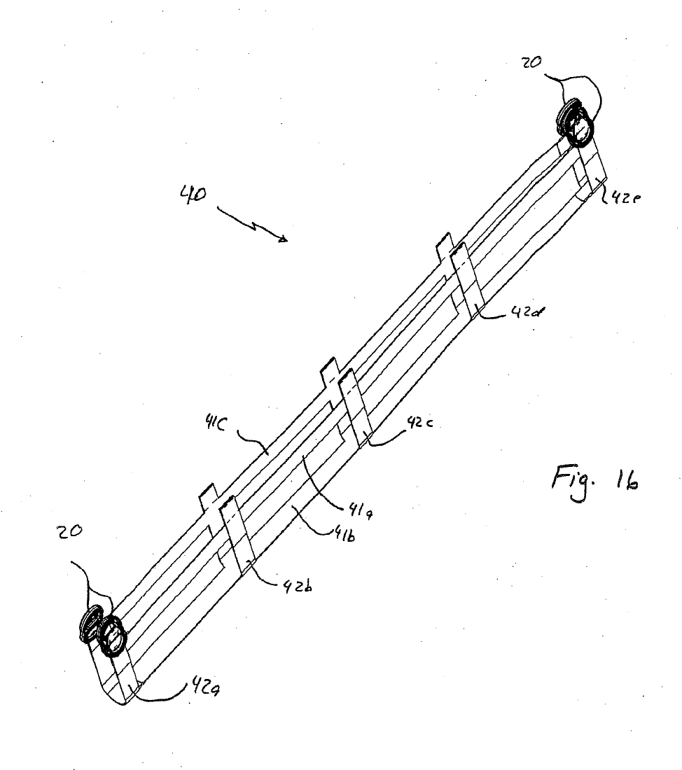

FIGS. 15 and 16 illustrate views of the cargo net 40 shown in FIGS. 12-14 in a folded position and ready to receive a load. In particular, the cargo net 40 is suitable for carrying long, rigid object such as a piece of plywood or gypsum board. The cargo net 40 may be folded generally along a longitudinal axis.

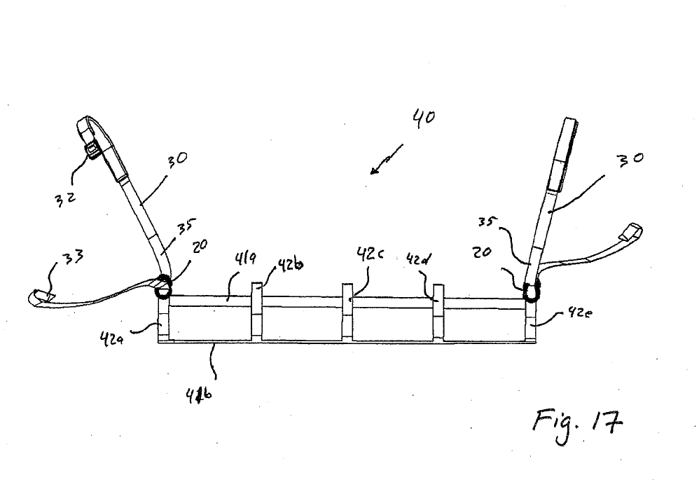

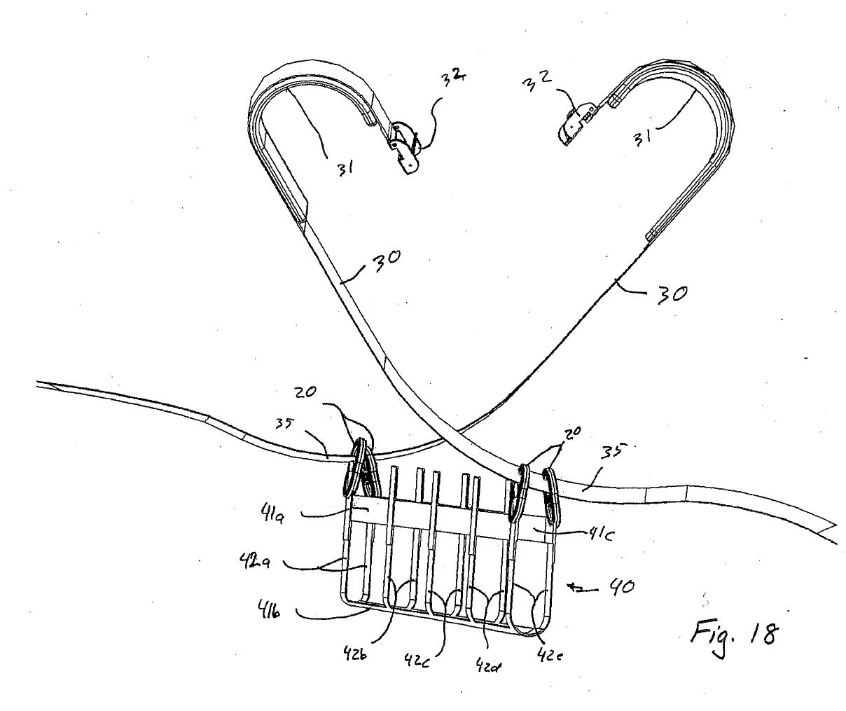

FIGS. 17 and 18 illustrate incorporation of straps 30 into the cargo net system. The straps 30, which may be attached at their end to form loops, are identical to the straps and loops described above. The straps include a connector at one end which can engage with the opposite end to form a loop, and the loop may include a shoulder portion.

As shown in FIGS. 17 and 18, a first strap 30 is threaded through the second opening 22 of two connectors 20 attached to adjacent corners of the cargo net 40. Similarly, a second strap 30 is threaded through the second opening 22 of the remaining two connectors 20 attached to adjacent corners of the cargo net. In one aspect, the adjacent corners are the two corners of the cargo net that have been brought together by virtue of the cargo net being folded along its longitudinal axis.

After the straps 30 are threaded through two connectors attached to adjacent corners of the cargo net, the connector 32 at one end of the strap receives the first end 33 of the strap to create loops. The loops may then be draped over the shoulder of a user in a kneeling position or over any other lift mechanism in a lowered position. When the user or lift rises, the slack in the loops is taken up, and eventually the cargo net 40 and any load located therein will be lifted off the ground.

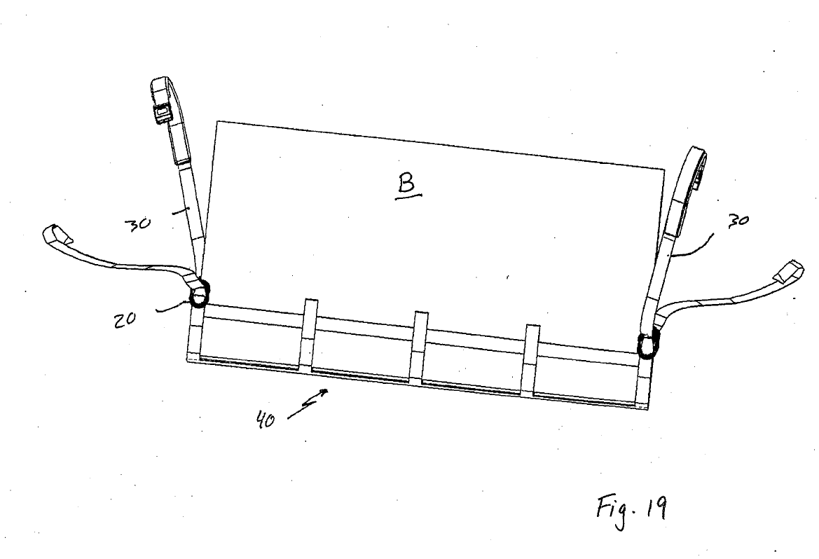

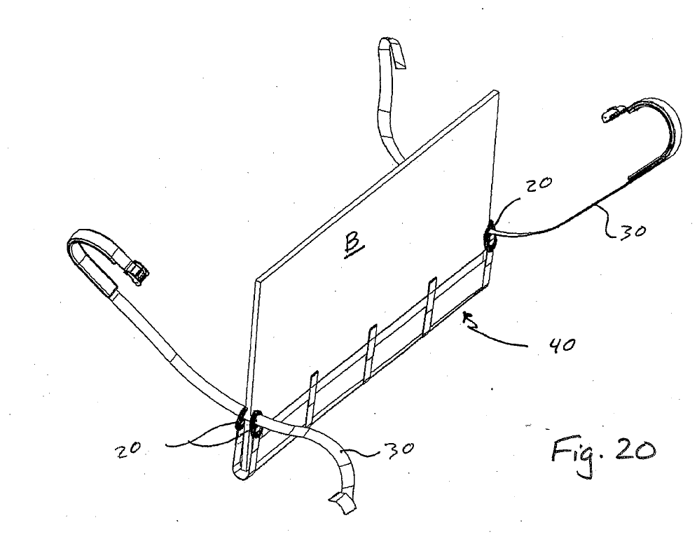

FIGS. 19 and 20 illustrate the cargo net strap system having an object B located in the cargo net 40. As can be seen, the straps 30 will close to forms loops, which may then be draped over the shoulder of a user for easy lifting and carrying of the object B.

Although the present invention has been described with respect to particular embodiments thereof, variations are possible. The present invention may be embodied in specific forms without departing from the essential spirit or attributes thereof. It is desired that the embodiments described herein be considered in all respects illustrative and not restrictive and that reference be made to the appended claims and their equivalents for determining the scope of the invention.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A strap system comprising:
a first loop, the first loop comprising a first strap having a first end and a second end, the first end comprising a first connector, wherein the second end is engaged in the first connector to thereby form the first loop;
a second loop, the second loop comprising a second strap having a first end and a second end, the first end comprising a second connector, wherein the second end is engaged in the second connector to thereby form the second loop;
and a figure-eight shaped connector having a first opening and a second opening, wherein the first loop is threaded through the first opening and the second loop is threaded through the second opening.

2. The strap system as claimed in claim 1, wherein the first and second connector each comprise a buckle.

3. The strap system as claimed in claim 1, wherein the first end of the first strap and the first end of the second strap each further comprise a padding.

4. The strap system as claimed in claim 3, wherein the padding of the first strap extends from the first connector to a predetermined distance down the length of the first strap and the width of the padding is about equal to the width of first strap and wherein the padding of the second strap extends from the second connector to a predetermined distance down the length of the second strap and the width of the padding is about equal to the width of the second strap.

5. The strap system as claimed in claim 1, wherein the first end of the first strap and the first end of the second strap each have a rigid J-shape for conforming to the shape of a shoulder of a user.

6. The strap system as claimed in claim 1, wherein the size of the first loop and the second loop is adjustable.

7. The strap system as claimed in claim 1, wherein the first opening and second opening in the figure-eight shaped connector each have rounded edges.

8. The strap system as claimed in claim 1, wherein the first strap and the second strap are uniform single straps devoid of supplemental straps or loops extending therefrom.

9. A strap system comprising:
a cargo net having four corners and being adapted for carrying an object;
a figure-eight shaped connector coupled to each of the four corners, wherein each of the figure-eight shaped connectors comprises a first opening and a second opening separated by a mid portion, and the corners of the cargo net are each coupled to one of the connectors via the mid portion of the connector;
a first loop, the first loop comprising a first strap having a first end and a second end, the first end comprising a first connector, wherein the second end is threaded through the second openings in two adjacent figure-eight shaped connectors and the second end is engaged in the first connector to thereby form the first loop;
and a second loop, the second loop comprising a second strap having a first end and a second end, the first end comprising a second connector, wherein the second end is threaded through the second openings in two adjacent figure-eight shaped connectors through which the first strap has not been threaded and the second end is engaged in the second connector to thereby form the second loop.

10. The strap system as claimed in claim 9, wherein the first and second connector each comprise a buckle.

11. The strap system as claimed in claim 9, wherein the first end of the first strap and the first end of the second strap each further comprise a padding.

12. The strap system as claimed in claim 11, wherein the padding of the first strap extends from the first connector to a predetermined distance down the length of the first strap and the width of the padding is about equal to the width of first strap and wherein the padding of the second strap extends from the second connector to a predetermined distance down the length of the second strap and the width of the padding is about equal to the width of the second strap.

13. The strap system as claimed in claim 9, wherein the first end of the first strap and the first end of the second strap each have a rigid J-shape for conforming to the shape of a shoulder of a user.

14. The strap system as claimed in claim 9, wherein the size of the first loop and the second loop is adjustable.

15. The strap system as claimed in claim 9, wherein the first opening and second opening in the figure-eight shaped connectors each have rounded edges.

16. The strap system as claimed in claim 9, wherein the first strap and the second strap are uniform single straps devoid of supplemental straps or loops extending therefrom.

17. A method for carrying a load comprising:
providing a plurality of loops and a loop connector, each loop being threaded through the loop connector;
positioning the loop connector under a load to be carried and positioning a portion of each of the plurality of loops to extend out from under the load to be carried;
positioning each portion of the plurality of loops extending out from under the load around one of a plurality of lifts; and
tensioning the plurality of loops by raising the lifts to thereby raise the load.

18. The method for carrying a load as claimed in claim 17, wherein the plurality of loops is two loops, the plurality of lifts is two lifts and the two lifts are positioned on opposite sides of a load to be carried.

19. The method for carrying a load as claimed in claim 18, wherein the two lifts are raised at the same time.

20. The method for carrying a load as claimed in claim 17, wherein the portions of the loops extending out from under the load are adapted to being draped over a shoulder of a user.
